(19) United States
(12) Patent Application Publication
(10) Pub. No.: US 2004/0246289 A1
(43) Pub. Date: Dec. 9, 2004

(54) Droplet placement sampling

(76) Inventor: Ezekiel J. Parnow, Poway, CA (US)

Correspondence Address: HEWLETT-PACKARD DEVELOPMENT COMPANY, Intellectual Property Administration, P.O. Box 272400, Fort Collins, CO, 80527-2400, US

(21) Appl. No.: 10/457,165

(22) Filed: Jun. 9, 2003

(51) Int. Cl. B41J 29/393

(52) U.S. Cl. 347/19

(57) ABSTRACT

One embodiment of a system is provided for sampling droplet placement in a printing mechanism having a printhead assembly that supports a printhead, wherein the system includes a test media holder removably coupled to the printhead assembly during sampling and a test media supported by the holder to receive sample droplets from the printhead

### BACKGROUND

Printing mechanisms, such as those used in inkjet printers, may use one or more print cartridges, sometimes referred to as “pens” which may shoot drops of liquid colorant, referred to generally herein as “ink,” onto print media, for instance paper or cardboard. Each print cartridge may have a printhead with very small nozzles through which the ink drops are fired using various technologies, such as thermal or piezo-electric inkjet technology. Between incremental advancing steps of the media through a printzone, the printhead may be propelled back and forth across the media while selectively firing drops of ink on the media to form a desired image. Some printing mechanisms, such as those in industrial settings, for example, may have a fixed or stationary media-wide array printhead, or a stationary group of off-set or “stitched” printheads, that print as the media is continuously moved through the printzone.

In printing mechanisms having one or more printheads it may be desirable to align the printhead(s) with respect to the position of the media during printing. In printing mechanisms having multiple printheads it may be desirable to align the printheads with respect to one another. For these and other reasons there is a need for the present invention.

### BRIEF DESCRIPTION OF THE DRAWINGS

FIG. 1 is a partially schematic, fragmented, perspective view of one embodiment of a printing mechanism including a printhead alignment system according to an embodiment of the present invention.

FIG. 2 is a perspective view of one embodiment of a test assembly of FIG. 1.

FIG. 3 is a perspective view of one embodiment of a stitched printhead arrangement of the printing mechanism of FIG. 1.

FIG. 4 is a flowchart illustrating one embodiment of a method of operating the alignment system of FIG. 1.

FIG. 5 is a perspective view of another embodiment of a test assembly.

FIG. 6 is a perspective view of another embodiment of a printhead assembly.

### DETAILED DESCRIPTION OF THE DRAWINGS

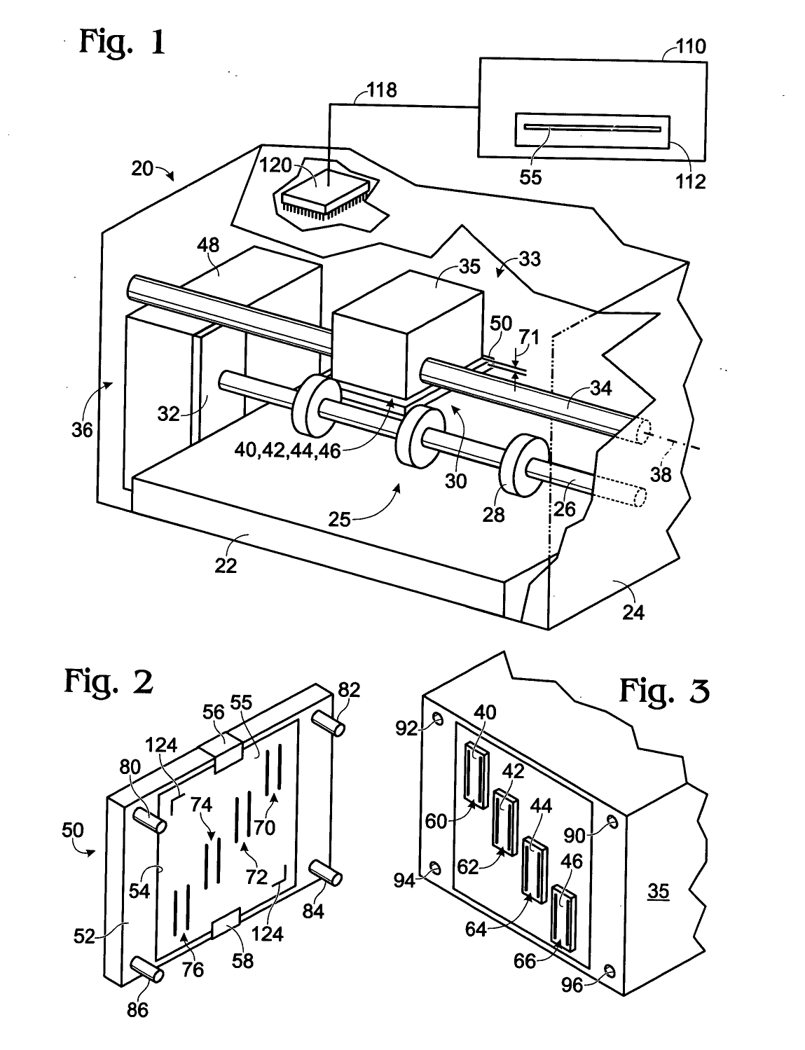

FIG. 1 illustrates one embodiment of a printing mechanism, here shown as a printer 20, which may include a base chassis 22, and an exterior housing 24. A media handling system 25 may include at least one drive roller shaft 26 which may include a series of media drive rollers, such as roller 28, which may propel media through a printzone 30 in incremental advances during printing. Alternatively, the shaft 26 and rollers 28 may be considered as a schematic representation of a drive portion of a conveyor assembly, such as a conveyor belt assembly (not shown), for continuously advancing media during printing. Drive roller shaft 26 may be rotatably supported by printer chassis 22, for example as shown at support 32.

Chassis 22 may fixedly support a printhead assembly 33 that may include a carriage support, shown as a guide rod 34. Printhead assembly 33 may further include a printhead carriage 35, here illustrated in a position above printzone 30, wherein printhead carriage 35 may be movably supported on guide rod 34. In a reciprocating carriage system, printhead carriage 35 may traverse through printzone 30 and into a servicing zone 36 along a scanning axis 38 defined by guide rod 34. Alternatively, in a fixed or stationary printhead carriage system, printhead assembly 33 may not be mobile, and instead may include a printhead mounted on chassis 22 which resides permanently over the printzone 30. The illustrated printer 20 of the present embodiment may be used for printing business reports, correspondence, advertising materials, product packaging, desktop publishing, and the like, in an office, home or other environment. A variety of printers are commercially available. For example, some of the printing mechanisms that may include embodiments of the present invention include industrial printers, package printers, plotters, portable printing units, copiers, cameras, video printers, and facsimile machines, to name a few.

In the illustrated embodiment of printer 20, carriage 35 supports four inkjet printheads 40, 42, 44 and 46 (see FIG. 3), although in other implementations other numbers of printheads may be used. Indeed, carriage 35 when used in a stationary or fixed printing system may be much wider than illustrated in FIG. 1, spanning the entire width of printzone 30, as measured along axis 38, known in the industry as a “page wide array” printer.

FIG. 2 shows an embodiment of an alignment test assembly 50, also shown in FIG. 1 in a test or sampling position under the printheads 40-46. Test assembly 50 may include a card holder body 52 which may be of a plastic, metal, paper or another somewhat rigid material. Card holder body 52 may include card alignment features, illustrated here as a slightly recessed window 54. The window 54, according to some embodiments, may be a rectangular recessed region of the card holder body 52. The window 54 may be sized to tightly maintain test media at least partially therein. Test assembly 50 may include a piece of test media (or may be the test media target surface itself, for example, if the target media is a disposable paper or cardboard assembly) such as test card 55, which may be located within window 54 for testing. In the embodiment where body 52 also functions as the test media, the test media may be supported by the printer's media support, such as a platen of the printer.

While the term “card” is used herein for convenience to refer to the test media, this term should in no way be limiting in that the test media may be a long strip of test media for page wide array inkjet printers, or a sheet for larger printhead arrays, or any other size or shape media as may be used in a particular application. Moreover, test card 55 may be stiff or flexible, depending on the particular application in which the test card is used. For example, if printer 20 is used as a package printer for printing cardboard, it may be desirable to use a piece of cardboard as the test card 55, or if printer 20 is used for printing on fabric, it may be desirable to use a piece of fabric as the test card 55. For the purposes of discussion herein, the illustrated embodiment of test card 55 is a high-quality premium or photographic paper.

Still referring to FIG. 2, test card 55 may be alternatively or additionally secured in place within window 54 by securing members, here illustrated as a pair of clips 56 and 58. In other implementations, other types of securing members may be used, for instance clamps (not shown), pins (not shown), adhesive tape (not shown), etc. In other embodiments, other card alignment features may be used, such as visible indicia markings (not shown) on body 52, or raised features, for instance ribs or ridges (not shown) protruding from the body. Clips 56 and 58 may also serve as card alignment features.

FIG. 3 shows four printheads 40-46 arranged in what is known in the art as a “stitched” or off-set printhead alignment. Printheads 40, 42, 44 and 46 may each have a pair of substantially linear nozzle arrays 60, 62, 64 and 66, respectively, although other printheads in other implementations may have different nozzle arrangements. FIG. 2 shows test card 55 as having four test patterns 70, 72, 74 and 76 made by sampling, i.e., ejecting ink from, the illustrated nozzle arrays 60, 62, 64 and 66, respectively.

Referring again to FIG. 2, to provide proper printhead-to-media spacing 71 (see FIG. 1), or as it is known in the art, pen-to-paper spacing (PPS), either test assembly 50, or carriage 35 (see FIG. 1), or both, may be equipped with a spacing feature, such as a pen-to-paper spacing mechanism, in the illustrated embodiment shown as four standoff posts 80, 82, 84 and 86 projecting from body 52. To align test assembly 50 with printheads 40-46 (see FIG. 3), a sampler alignment or datum mechanism may be used. In the embodiment shown the alignment mechanism may include four alignment holes 90, 92, 94 and 96 which may be positioned on carriage 35. The holes may be located to receive and correspond to standoff posts 80, 82, 84 and 86, respectively. Holes 90, 92, 94 and 96 may have a depth such that only a predetermined or selected length of posts 80, 82, 84 and 86, respectively, are received within holes 90, 92, 94 and 96. In this manner, holes 90, 92, 94 and 96 may determine the pen-to-paper spacing 71 (see FIG. 1), i.e., the media to printhead spacing, of the test assembly. In a fixed printhead embodiment, all or a part of the alignment mechanism may be positioned on printhead assembly 33 that supports printheads 40, 42, 44 and 46 in a stationary position. For example, printhead assembly 33 may comprise a support wall (not shown) fastened to chassis 22 (see FIG. 1) wherein the printheads are secured to the support wall (not shown) and the alignment mechanism, such as holes 90, 92, 94 and 96, may be positioned on the support wall adjacent the printheads.

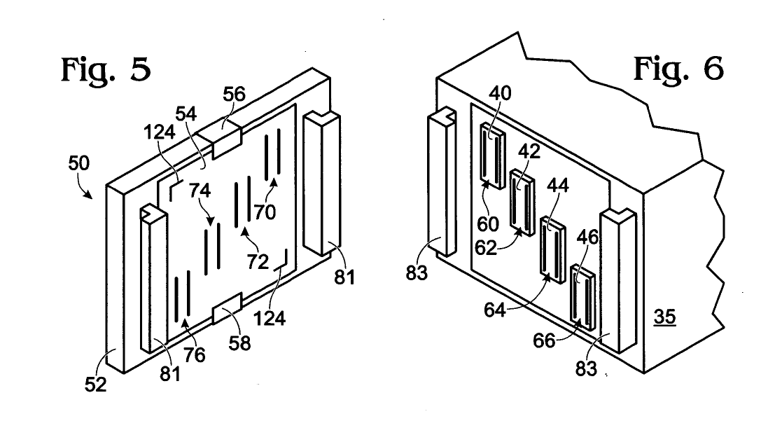

This arrangement of standoff posts 80-86 and corresponding alignment holes 90-96 addresses both the issues of proper pen-to-paper spacing and alignment of test assembly 50 with printheads 40-46 (see FIG. 3). Other mechanical fixtures and devices may be employed to address the PPS and alignment issues. For example, using a pair of mating rail features (see FIGS. 5 and 6) such as rails 81 on test assembly 50 and rails 83 on carriage 35, may allow the test assembly to be slid into a test position under printheads 40-46. The standoff post and corresponding alignment hole arrangement illustrated in FIGS. 2 and 3 is shown merely by way of example, and is in no way intended to be limiting on the scope of the claims appended below. In an alternative embodiment, the holes may be positioned on test assembly 50 and the posts may be positioned on printhead carriage 35. However, in such an embodiment, posts extending outwardly from printhead 35 may disrupt print media as it passes by the printheads during normal printing operations.

An alternative to the card alignment device comprising recessed window 54 may comprise an arrangement and size of card 55 or of standoff posts 80-86, such that the posts retain card 55 in an aligned position on test assembly 50. For example, the edges of card 55 may define cutouts which surround a portion of the standoff posts, or the card may define holes therethrough sized to completely surround the standoff posts. Similarly, the card edges may have cutouts sized to engage clips 56 and 58 and which may serve as card alignment features.

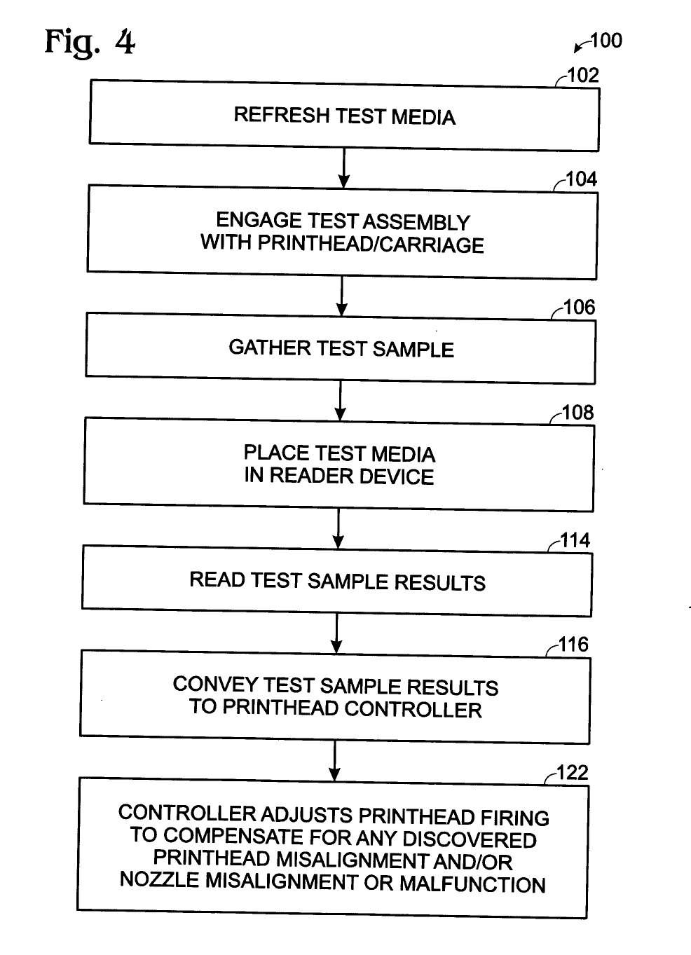

FIG. 4 shows one embodiment of a nozzle testing and alignment method 100 for adjusting droplet placement on print media. First, in a refreshing operation 102, fresh test card 55 may be placed within window 54 of body 52, and may be secured in place using clips 56 and 58. Optionally, however, as discussed above, in embodiments where the test patterns are formed directly on the body 52, the test card 55 is not mounted on the body 52. Next, in an engaging operation 104, test assembly 50 may be placed in a test position adjacent to printheads 40-46 by inserting standoff posts 80-86 (see FIG. 2) into their respective associated alignment holes 90-96 (see FIG. 3). Posts 80-86 may be sized such that they are frictionally retained within holes 90-96 during testing of the printheads such that test assembly 50 is secured to printhead carriage 35 in a hands-free manner. While the illustrated embodiment of FIG. 1 shows test assembly 50 attached in a hands-free manner to carriage 35, in other implementations, an operator may hold test assembly 50 in the test position.

Thereafter, in a gathering operation 106, a test sample may be gathered by having the nozzles of each array 60-66 (see FIG. 3) eject a single droplet onto test card 55, forming respective test patterns 70-76 (see FIG. 2). Before engaging operation 104, an optional action of spitting or purging each of the nozzles of printheads 40-46 may be performed. For example, several primer spits may serve to remove any minor blockages or occlusions, such as partially dried ink, from a nozzle which has been inactive. Optionally, an entire printhead servicing routine may be performed before engaging operation 104 to assure the printheads are clean and ready to fire an acceptable or satisfactory sample.

After gathering operation 106, test assembly 50 may be removed from carriage 35, and sample card 55 may be removed from body 52 and placed into a reader device 110 (see FIG. 1). Reader device 110 is illustrated as having an input slot 112, although in other embodiments a conventional flatbed scanner may be used to conduct reading operation 114. Reader device 110, which may comprise any of a variety of scanning devices, may scan test sample images 70-76 (see FIG. 2) and gather information such as where the droplets actually landed in the test patterns. The resolution of reader device 110 may be selected to be greater than or equal to the printhead resolution (e.g. 600 or 1200 dots per inch, or “DPI”) to generate test data.

In a conveying operation 116, the test sample results may be conveyed via a communication channel 118 to a printer controller 120. The conveying operation 116 is illustrated schematically in FIG. 1, and may comprise an electric, optic, radio wave or other signal sent from reader device 110 to controller 120. In another implementation, the conveying operation may comprise reader device 110 storing the test result information on a magnetic, optic or other memory medium, which an operator may carry from reader device 110 to an input device on printer 20 or to an input device on a separate computer (not shown) that may control printer 20. The term “printer controller” as used herein may include operations conducted by the onboard electronics of printer 20, by driver software resident within a separate computer (not shown) that controls printer 20, or by a combination thereof.

In an adjusting operation 122, controller 120 analyzes test data and may adjust printer mechanism settings, such as the nozzle firing sequencing to compensate for any printhead and/or nozzle misalignment discovered using any of a variety of conventional or other nozzle compensation imaging programs. For example, imaging software may calculate the distance in pixels from one printhead's nozzle pattern to another in both horizontal and vertical directions. Such software may then recommend an image shift in pixels for each of the other printheads, or the software may communicate directly with printer controller 120 so adjustments may be made automatically by the printer electronics. Method 100 may also be used to diagnose printhead health. In particular, imaging software may be constructed that may be capable of detecting missing and misaligned droplets within test patterns 70-76 (see FIG. 2). Using adjusting operation 122, a missing droplet may be compensated for by adjusting a printer mechanism setting such as firing another nozzle(s) as a substitute. Similarly, misdirected or misaligned droplets may be compensated for by adjusting the firing time of the nozzle, or assigning some other nozzle(s) to fire instead. Optionally, using a high-quality print media for test card 55, such as coated premium or photographic media, may mitigate drop-bleed into the media fibers, and may provide high-resolution test patterns 70-76 (see FIG. 2) to conduct such printhead health diagnosis routines. Thus, on a broader scale, method 100 may be considered as an inkjet droplet placement sampling and correction method, which may be used to detect and correct printhead to print media misalignment, printhead to printhead misalignment, and to detect printhead health issues, such as missing or misaligned nozzles.

To compensate for any image skew or rotation, test card 55 may include preprinted reference indicia, such as horizontal and vertical markings 124 (see FIG. 2). Reference indicia 124 may also be scanned during reading operation 114, and conveyed in operation 116 to controller 120. During the adjusting operation 122, controller 120 may use the position of the reference indicia 124 to determine whether any of the test patterns 70-76 (see FIG. 2) are rotated with respect to the reference markings, and then compensate for such rotation, if any, by adjusting the nozzle firing sequence. Other patterns of reference indicia may be used, such as a company or brand logo, printed information about the types of printers the test card accommodates, blank lines for an operator to record information about the test sample, phrases, a logo or design, etc. Preprinted or blank test media may be packaged and sold as a consumable product sized to fit the particular body 52 recommended for a particular printhead configuration.

The illustrated example embodiments of FIGS. 1-6 are shown to illustrate the principles and concepts of the invention as set forth in the claims below, and a variety of modifications and variations may be employed in various implementations while still falling within the scope of the claims below.

1. A system for sampling droplet placement in a printing mechanism having a printhead assembly that supports a printhead, comprising:
a test media holder removably coupled to the printhead assembly during sampling; and
a test media supported by said holder to receive sample droplets from the printhead.

2. A system according to claim 1, further comprising a test media reader device which examines the test media and generates sample droplet placement information, and a controller configured to generate correction information used to change printing mechanism settings based on the sample droplet placement information.

3. A system according to claim 2, further comprising a communication link between the reader device and the controller to communicate said information to the controller.

4. A system according to claim 1 further comprising an alignment structure on said test media holder that establishes a selected printhead to test media spacing during sampling.

5. A system according to claim 1 further comprising an alignment structure on said test media holder that engages corresponding alignment structure on said printhead assembly.

6. A system for sampling droplet placement in a printing mechanism having a printhead assembly that supports a printhead, comprising:
a test media holder removably coupled to the printhead assembly during sampling;
a test media supported by said holder to receive sample droplets from the printhead; and
an alignment structure on said test media holder that engages corresponding alignment structure on said printhead assembly wherein said alignment structure comprises projections and said corresponding alignment structure comprises holes.

7. A system according to claim 1 wherein the test media holder further includes media alignment structure to align the test media.

8. A system according to claim 1 wherein the test media holder further includes a media retention device to secure the test media to said holder during sampling.

9. A system according to claim 7 wherein the media alignment structures comprises a recessed region for receiving said test media therein.

10. A system according to claim 1, further comprising:
a test media reader device which examines the test media and generates sample droplet placement information;
a controller which interprets said information and generates correction information used to change printer mechanism settings;
a communication link between the reader device and the controller to communicate said information to the controller; and
an alignment structure on the test media holder that establishes a selected printhead to test media spacing during sampling, engages corresponding alignment structure on the printhead assembly, and couples the test media holder to the printhead assembly during sampling;
wherein the test media holder further includes media alignment features to align the test media, and media retention features to secure the test media to said holder during sampling.

11. A test media holder comprising:
a body having a first surface for maintaining test media in a position thereon to receive test droplets ejected from a printhead during testing; and
alignment features formed at the first surface for removably engaging the body during testing with a printhead assembly that supports said printhead.

12. A holder according to claim 11 wherein said alignment features establish a selected printhead to test media spacing during testing.

13. A holder according to claim 11 wherein said alignment features engage corresponding alignment features on said printhead assembly.

14. A holder according to claim 11 wherein the test media holder further includes media alignment features to align the test media.

15. A holder according to claim 11 wherein the test media holder further includes media retention features to secure the test media to said holder during sampling.

16. A test media comprising:
a body having a sample surface, the body sized to be removably supported by a test media support; and
alignment features positioned on said body that removably engage an inkjet printhead assembly during ejection of test inkjet droplets onto the sample surface.

17. A test media according to claim 16, wherein the sample surface has alignment indicia preprinted thereon prior to ejection of said test inkjet droplets.

18. A sampling apparatus for capturing test droplets ejected from a printhead assembly, comprising:
means for receiving sample droplets from the printhead assembly; and
means for holding said means for receiving in a test position adjacent the printhead assembly, said means for holding being adapted for removably coupling to the printhead assembly during testing.

19. A sampling apparatus according to claim 18 wherein said means for holding comprises means for maintaining a selected spacing between said printhead assembly and said means for receiving during sampling.

20. A sampling apparatus according to claim 18 wherein said means for holding comprises means for attaching said means for holding in place adjacent said printhead assembly during sampling.

21. A sampling apparatus according to claim 18 wherein said means for holding comprises means for aligning said means for receiving.

22. A sampling apparatus according to claim 18 further comprising means for attaching said means for receiving to said means for holding during sampling.

23. A system for sampling and correcting droplet placement in a printing mechanism having a printhead, comprising:
media means for receiving sample droplets from the printhead;
means for holding the media means in a test position adjacent the printhead, wherein said means for holding is coupled to said printhead when said media means receives sample droplets from the printhead;
means for examining the sample droplets and generating drop placement information in response thereto; and
means for interpreting said information and changing droplet placement in response thereto.

24. A method of correcting inkjet droplet placement in a printing mechanism having a printhead assembly, comprising:
securing test media on a test media holder;
engaging said holder with the printhead assembly;
collecting sample droplets on the test media;
disengaging said holder from the printhead assembly;
analyzing the sample droplets; and
adjusting printing mechanism settings in response to said analyzing.

25. A method according to claim 24 further comprising:
removing the test media from said holder; and
wherein said analyzing comprises reading the test media with a reader device.

26. A method according to claim 24 for use with an inkjet printing mechanism having plural printheads assemblies, wherein:
said analyzing comprises analyzing printhead assembly to printhead assembly alignment; and
said adjusting comprises correcting errors in said printhead assembly to printhead assembly alignment.

27. A method according to claim 24 wherein:
said analyzing comprises detecting a missing droplet from a defective nozzle of said printhead assembly; and
said adjusting comprises substituting a functioning nozzle for said defective nozzle.

28. A method according to claim 24 wherein:
said analyzing comprises detecting a misaligned droplet ejected from a malfunctioning nozzle of said printhead assembly; and
said adjusting comprises adjusting a firing time of said malfunctioning nozzle.

29. A method according to claim 24 wherein:
said analyzing comprises analyzing a location of said sample droplets with respect to reference indicia preprinted on said test media prior to said securing; and
said adjusting comprises adjusting a firing time of nozzles of the printhead assembly to correct image skew.

30. A sampling apparatus for capturing test droplets ejected from a printhead assembly, comprising:
a test media for receiving test droplets thereon; and
a printhead assembly including a printhead for ejecting test droplets therefrom and a coupling feature that removably couples said test media to said printhead assembly during ejection of said test droplets.

31. A sampling apparatus according to claim 30 wherein said test media includes a corresponding coupling feature that is removably coupled to said printhead assembly coupling feature during ejection of said test droplets.

32. A sampling apparatus for capturing test droplets ejected from a printhead assembly, comprising:
a test media for receiving test droplets thereon; and
a printhead assembly including a printhead for ejecting test droplets therefrom and a coupling feature that removably couples said test media to said printhead assembly during ejection of said test droplets;
wherein said test media includes a corresponding coupling feature that is removably coupled to said printhead assembly coupling feature during ejection of said test droplets, wherein said coupling feature comprises a rail, wherein said corresponding coupling feature comprises a mating rail, and wherein said rail is slidingly coupled to said mating rail during ejection of said test droplets.

33. A system for sampling droplet placement in a printing mechanism, comprising:
test media structure including a sample surface for receiving test droplets thereon and an engagement feature; and
a printhead assembly including a printhead for ejecting test droplets therefrom and a corresponding engagement feature that removably engages said engagement feature during ejection of said test droplets.

34. A system for sampling droplet placement in a printing mechanism, comprising:
test media structure including a sample surface for receiving test droplets thereon and an engagement feature; and
a printhead assembly including a printhead for ejecting test droplets therefrom and a corresponding engagement feature that removably engages said engagement feature during ejection of said test droplets,
wherein said test media structure includes a test media holder and a test media removably positioned thereon and including said sample surface, said engagement feature comprises a rail positioned on said test media holder, and said corresponding engagement feature comprises a mating rail slidingly engaged with said rail during ejection of said test droplets.
